(19) United States
(12) Patent Application Publication
(10) Pub. No.: US 2013/0272842 A1
(43) Pub. Date: Oct. 17, 2013

(54) FLUID TURBINE WITH HYBRID YAW

(71) Applicant: FLODESIGN WIND TURBINE CORP., Waltham, MA (US)

(72) Inventor: Bjarne Juhl, Silkeborg (DK)

(73) Assignee: FLODESIGN WIND TURBINE CORP., Waltham, MA (US)

(21) Appl. No.: 13/861,034

(22) Filed: Apr. 11, 2013

Related U.S. Application Data
(60) Provisional application No. 61/622,814, filed on Apr. 11, 2012.

(51) Int. Cl. F03D 1/04

(52) U.S. Cl. CPC F03D 1/04
USPC 415/1; 415/2.1

(57) ABSTRACT

Example embodiments are directed to shrouded fluid turbines that include a turbine shroud and a rotor. The turbine shroud includes a plurality of mixer elements and the rotor can be disposed within the turbine shroud. The shrouded fluid turbine further includes a hybrid yaw system having a passive yaw system and an active yaw system for regulating a yaw of the shrouded fluid turbine. The hybrid yaw system further includes a torque limiter. Example embodiments are also directed to methods of yawing a shrouded fluid turbine. Example embodiments are further directed to hybrid yaw systems for a shrouded fluid turbine that includes a shrouded fluid turbine assembly rotationally engaged with a tower. The hybrid yaw system includes a passive yaw system and an active yaw system associated with the shrouded fluid turbine.

### CROSS-REFERENCE TO RELATED APPLICATIONS

The present application claims the benefit of a U.S. provisional patent application entitled “Fluid Turbine With Hybrid Yaw” which was filed on Apr. 11, 2012, and assigned Ser. No. 61/622,814. The entire content of the foregoing provisional application is incorporated herein by reference.

### TECHNICAL FIELD

The present disclosure relates to turbines for power generation and, in particular, to shrouded fluid turbines with a hybrid yaw system, i.e., a combination passive and active yaw system, for the purpose of yawing the shrouded fluid turbines into the fluid-flow direction and protecting the shrouded fluid turbines and motorized yaw equipment in the event of excessive fluid speeds, loss of connection to grid power and other system protection modes.

### BACKGROUND

Conventionally, horizontal axis fluid turbines used for power generation include one to five open blades arranged like a propeller and a rotor attached at a hub. The blades are generally mounted to a horizontal shaft attached to a gear box which drives a power generator. Typically, the gearbox and generator equipment are further housed in a nacelle. Some turbines employ a passive system for rotating the turbine about a vertical axis to direct the rotor into the wind, while other turbines employ a motorized system.

In the field of fluid energy conversion, turbines are typically mounted on the main vertical support structure at the approximate center of gravity of the turbine. Larger turbines conventionally employ mechanical yaw systems as they are engaged with a support structure about a pivot axis that is located near the center of gravity and also resides near the center of pressure. The turbine configurations in which the location of the pivot axis is aligned with respect to the location of the center of pressure generally result in thrust forces on the turbine that do not appropriately yaw the turbine to the desired direction. Thus, continuous control from an active yaw component is generally required.

### SUMMARY

In accordance with example embodiments of the present disclosure, shrouded fluid turbines, e.g., shrouded liquid turbines, shrouded air turbines, and the like, are taught that efficiently and effectively position the shrouded fluid turbine relative to wind direction by a combination of a passive yaw system and an active yaw system. A passive yaw system which can be capable of yawing the shrouded turbine appropriately into the wind can be referred to as a functional-passive yaw system or a continuous-passive yaw system. The employment of a functional-passive yaw system without the use of an active yaw system can be referred to as full-passive yaw. An active yaw system required to yaw the shrouded turbine to the desired direction can be referred to as a controlling-active yaw system or a momentary-active yaw system. A system that utilizes functional-passive yaw in combination with an active yaw system can be referred to as supporting-active yaw or a hybrid yaw system. A cut-in fluid velocity of a shrouded turbine generally defines the fluid velocity at which the shrouded turbine can begin generating electrical energy. The cut-out fluid velocity of a shrouded turbine generally defines the point at which the shrouded turbine is shut down to prevent damage to electrical generation and mechanical components due to excessive fluid velocity that would result in excessive rotor speed.

The shrouded turbines discussed herein, e.g., shrouded fluid turbines that include mixer-ejector turbines (MET), as well as shrouded turbines free of an ejector shroud, generally engage with a support structure near the center of gravity of the shrouded turbine while pivoting about the support structure about an axis that may be offset from the center of pressure of the shrouded turbine. Pivoting about an axis that is offset from the center of pressure causes the shrouded turbine to have a tendency to move to a position in which the center of pressure remains downstream of the pivot axis. This provides passive yaw when the fluid stream is of sufficient strength, e.g., from cut-in fluid velocity to cut-out fluid velocity. Although the effects of passive yaw may be present in most fluid velocities, a braking system can be included to prevent the function of the passive yaw system before cut-in fluid velocity and after cut-out fluid velocity.

An active yaw system, e.g., a motor driven yaw system, can be employed to rotate the rotor plane about the vertical axis of a shrouded fluid turbine into the direction of the fluid, e.g., air, liquid, and the like. The active yaw system can be disposed between a tower top and the nacelle. For example, the components of the active yaw system may be situated in the nacelle or in the tower. The active yaw system can include at least one adjustment drive, which may be equipped with a gearbox, and a yaw bearing engaged with a ring gear. After completed yaw adjustment of the nacelle, the nacelle can be immobilized by brake units of the active yaw system.

Although the aerodynamic principles of the shrouded fluid turbines discussed herein are with respect to air, it should be understood that the aerodynamic principles of the shrouded fluid turbines are not restricted to air and apply to any fluid, e.g., any liquid, gas, or combinations thereof, and therefore including water as well as air. For example, the aerodynamic principles of a shrouded mixer-ejector turbine apply to hydrodynamic principles in a shrouded mixer ejector water turbine. Further, for the purpose of convenience, the present example embodiments are described in relation to shrouded turbine applications, both mixer-ejector turbines and shrouded turbines free of an ejector shroud. However, it should be understood that such description is solely for convenience and clarity and is not intended to be limiting in scope.

In accordance with example embodiments of the present disclosure, shrouded fluid turbines, e.g., shrouded axial-flow fluid turbines, are taught that include one or more rotor blades engaged with a hub. The hub can be further engaged with a shaft that can be engaged with electrical generation equipment housed in a nacelle. In some embodiments, the shrouded fluid turbine can be a single shroud fluid turbine and can include a ring of mixer elements. In some embodiments, the shrouded fluid turbine can be a double shroud fluid turbine and can include an ejector shroud surrounding the ring of mixer elements. The mixer elements can extend downstream of the rotor blade and downstream and towards the ejector shroud.

The shrouded fluid turbine can include an engagement structure between the shrouded turbine and the support structure which can include a combination of a momentary-active and a continuous-passive yaw system. The controlling-active yaw system can slip when over-torqued via a torque limiting mechanism. In particular, in some embodiments, the controlling-active yaw system can include at least one drive shaft rotationally engaged with a pinion gear. The pinion gear can be engaged with a friction material that can be engaged with at least one pressure plate that is laterally engaged with the drive shaft.

In accordance with example embodiments of the present disclosure, shrouded fluid turbines, e.g., shrouded fluid turbines that include mixer-ejector turbines, as well as shrouded turbines free of an ejector shroud, are taught that include a turbine shroud with mixing elements surrounding a rotor. In some example embodiments, the shrouded turbines include an ejector shroud in fluid communication with the mixing elements of the turbine shroud.

In accordance with example embodiments of the present disclosure, shrouded fluid turbines are taught that include a turbine shroud which includes a plurality of mixer elements and a rotor disposed within the turbine shroud. The shrouded fluid turbines further include a hybrid yaw system having a passive yaw system and an active yaw system for regulating a yaw of the shrouded fluid turbine. The hybrid yaw system further includes a torque limiting mechanism.

The shroud of the fluid turbine can define a turbine shroud inlet and a turbine shroud outlet. The rotor can be further disposed downstream of the turbine shroud inlet and can include a hub and at least one rotor blade engaged with the hub. The plurality of mixer elements can extend downstream of the at least one rotor blade. The plurality of mixer elements can further be arranged in, e.g., a ring or circular configuration. In some embodiments, the shrouded fluid turbine includes an ejector shroud surrounding the plurality of mixer elements. The ejector shroud can define an ejector shroud inlet and an ejector shroud outlet. In some embodiments, at least one of the turbine shroud and the ejector shroud can include faceted sides. The shrouded fluid turbine further includes a nacelle including therein electrical generation equipment.

The passive yaw system of the hybrid yaw system can be a continuous-passive yaw system. The active yaw system of the hybrid yaw system can be, e.g., a momentary-active yaw system, a controlling-active yaw system, a supporting-active yaw system, or combinations thereof. The passive yaw system can be engaged from a cut-in fluid velocity to a cut-out fluid velocity. The controlling-active yaw system can be engaged from the cut-in fluid velocity to a predetermined velocity range, e.g., between approximately 8 m/s to approximately 12 m/s. A combination of the passive yaw system and the supporting-active yaw system can be engaged between the predetermined fluid velocity range, e.g., between approximately 8 m/s to approximately 12 m/s, and the cut-out fluid velocity.

The torque limiting mechanism of the active yaw system can include, e.g., at least one drive shaft, a pinion gear, a friction material, at least one pressure plate, and the like. The at least one drive shaft can be rotationally engaged with the pinion gear. The pinion gear can be engaged with the friction material. The friction material can be engaged with the at least one pressure plate. The at least one pressure plate can be laterally engaged with the at least one drive shaft. The torque limiting mechanism can thereby allow slippage of the pinion gear relative to the at least one drive shaft when the at least one drive shaft is over-torqued.

In accordance with example embodiments of the present disclosure, methods of yawing a shrouded fluid turbine are taught that include providing the shrouded fluid turbine. The shrouded fluid turbine includes a turbine shroud including a plurality of mixer elements and a rotor disposed within the turbine shroud. The shrouded fluid turbine further includes a hybrid yaw system having a passive yaw system and an active yaw system for regulating a yaw of the shrouded fluid turbine. The hybrid yaw system further includes a torque limiting mechanism. The example methods include yawing the shrouded fluid turbine via the hybrid yaw system. The passive yaw system and the active yaw system can thereby be utilized to yaw the shrouded fluid turbine into a fluid-flow direction. The passive yaw system can be a continuous-passive yaw system and the active yaw system can be at least one of a momentary-active yaw system, a controlling-active yaw system and a supporting-active yaw system.

In accordance with example embodiments of the present disclosure, hybrid yaw systems for a shrouded fluid turbine are taught that include a shrouded fluid turbine assembly rotationally engaged with a tower. The hybrid yaw systems further include a passive yaw system and an active yaw system associated with the shrouded fluid turbine assembly. At least one of the passive yaw system and the active yaw system regulate a yaw of the shrouded fluid turbine assembly relative to the tower. The active yaw system can be at least one of a controlling-active yaw system and a supporting-active yaw system. The active yaw system can further include a torque limiting mechanism.

Other objects and features will become apparent from the following detailed description considered in conjunction with the accompanying drawings. It is to be understood, however, that the drawings are designed as an illustration and not as a definition of the limits of the invention.

### BRIEF DESCRIPTION OF THE DRAWINGS

To assist those of skill in the art in making and using the disclosed shrouded turbines and associated systems methods, reference is made to the accompanying figures, wherein:

FIG. 1 is a front perspective view of an example shrouded turbine according to the present disclosure;

FIG. 2 is a side view of an example shrouded turbine including a center of gravity, a center of pressure and a pivot point according to the present disclosure;

FIG. 3 is a top perspective detailed view of an example active yaw system according to the present disclosure;

FIG. 4 is a bottom perspective detailed view of an example active yaw system according to the present disclosure;

FIG. 5 is a side, cross-sectional and detailed view of an example active yaw system according to the present disclosure;

FIG. 6 is a diagram illustrating the relationship between fluid-flow velocities and employment of passive and active yaw systems according to the present disclosure;

FIG. 7 is a front perspective view of an example shrouded turbine according to the present disclosure;

FIG. 8 is a side view of an example shrouded turbine including a center of gravity, a center of pressure and a pivot point according to the present disclosure;

FIG. 9 is a front perspective view of an example shrouded fluid turbine according to the present disclosure;

FIG. 10 is a rear perspective view of an example shrouded fluid turbine according to the present disclosure;

FIG. 11 is a side cross-sectional view of an example shrouded fluid turbine including a center of gravity, a center of pressure and a pivot point according to the present disclosure;

FIG. 12 is a front perspective view of an example shrouded fluid turbine according to the present disclosure;

FIG. 13 is a rear perspective view of an example shrouded fluid turbine according to the present disclosure; and

FIG. 14 is a side cross-sectional view of an example shrouded fluid turbine including a center of gravity, a center of pressure and a pivot point according to the present disclosure.

### DESCRIPTION

Although specific terms are used in the following description, these terms are intended to refer to particular structures in the drawings and are not intended to limit the scope of the present disclosure. It is to be understood that like numeric designations refer to components of like function.

The term “about” or “approximately” when used with a quantity includes the stated value and also has the meaning dictated by the context. For example, it includes at least the degree of error associated with the measurement of the particular quantity. When used in the context of a range, the term “about” or “approximately” should also be considered as disclosing the range defined by the absolute values of the two endpoints. For example, the range “from about 2 to about 4” or “from approximately 2 to approximately 4” also discloses the range “from 2 to 4.”

The shrouded fluid turbines discussed herein, e.g., shrouded fluid turbines that include mixer-ejector turbines, as well as shrouded turbines free of an ejector shroud, provide advantageous systems for generating power from fluid currents. The fluid currents discussed herein may be, but are not limited to, e.g., gas currents, liquid currents, such as air and water. In example embodiments of shrouded turbines free of an ejector shroud, the turbine shroud encloses a rotor which extracts power from a primary fluid stream. The turbine shroud brings fluid flow through the rotor and allows energy extraction due to the flow rate.

In example embodiments of the shrouded mixer-ejector turbines which include an ejector shroud, the shrouded turbines can include tandem cambered shrouds and a mixer/ejector pump. The turbine shroud encloses a rotor which extracts power from a primary fluid stream. The tandem cambered shrouds and ejector bring more flow through the rotor allowing more energy extraction due to higher flow rates. The mixer/ejector pump transfers energy from the bypass flow, that is, fluid flow that flows past the exterior of the turbine shroud, to the rotor wake flow allowing higher energy per unit mass flow rate through the rotor. These effects enhance the overall power production of the example shrouded turbine system.

The term “rotor” is used herein to refer to any assembly in which one or more blades are attached to a shaft and able to rotate, allowing for the extraction of power or energy from fluid rotating the blades. The fluid rotating the blades can include, e.g., gas, liquid, or combinations thereof. Example rotors can include a propeller-like rotor or a rotor/stator assembly. Any type of rotor may be enclosed within the turbine shroud in the shrouded turbine of the present disclosure.

The leading edge of a turbine shroud may be considered the front of the shrouded fluid turbine, and the trailing edge of an ejector shroud may be considered the rear of the shrouded fluid turbine. Each of the turbine shroud and the ejector shroud can define an inlet and an outlet, the outlet being located downstream of the inlet. In particular, a first component of the shrouded fluid turbine located closer to the front of the shrouded turbine may be considered “upstream” of a second component located closer to the rear of the shrouded turbine. Thus, the second component is “downstream” of the first component.

The present disclosure relates to a shrouded fluid turbine system, method and apparatus for yawing the shrouded turbine into the appropriate direction with respect to the fluid direction that employs a functional-passive yaw system in combination with controlling-active and supporting-active yaw systems. As recited herein, the use of a functional-passive yaw system in combination with controlling and supporting-active yaw systems can be referred to as a hybrid yaw system.

An example embodiment relates, in general, to a shrouded fluid turbine including an annular airfoil, referred to herein as a ringed or circular turbine shroud, that surrounds a rotor. In another example embodiment, the shrouded fluid turbine may further include an ejector shroud that surrounds the exit, i.e., outlet, of the turbine shroud. Although discussed herein as a circular or ring shroud, it should be understood that in some embodiments, other configurations, e.g., square, rectangular, oval, and the like, of the shrouds can be used. The turbine shroud and the ejector shroud can be integrated with a functional-passive yaw system in combination with a controlling and a supporting active-yaw system, i.e., a hybrid yaw system. As will be discussed in greater detail below, in some embodiments, the shrouded turbine can include a yaw drive that can limit torque created by the active yaw system by utilizing a pinion engaged with a friction material, the friction material being further engaged with pressure plates such that the pinion can be engaged with rotating components by way of said friction material.

In some embodiments, the turbine shroud can include a set of mixing elements or lobes along the trailing edge, i.e., outlet of the turbine shroud, that are in fluid communication with the inlet of the ejector shroud. In some example embodiments, the turbine shroud includes an annular leading edge that transitions to a faceted trailing edge. The faceted trailing edge can, in turn, be in fluid communication with a faceted ejector shroud. In some example embodiments, an annular turbine shroud having a constant cross-section can be in fluid communication with an annular ejector shroud having a constant cross-section. In example embodiments including a turbine shroud free of an ejector shroud, the mixer elements provide an increased fluid velocity near the inlet of the turbine shroud at the cross-sectional area of the rotor plane. In example embodiments including a turbine shroud and an ejector shroud, the mixer elements and the ejector shroud form a mixer-ejector pump which provides increased fluid velocity near the inlet of the turbine shroud at the cross-sectional area of the rotor plane. The mixer-ejector pump further energizes the wake behind the rotor plane. The combination of the effects of the mixing lobes and the energized wake provides a rapidly-mixed shorter wake compared to the wake of non-shrouded horizontal axis wind turbines.

In some embodiments, the turbine shroud, the mixer elements, the faceted trailing edge or annular trailing edge, and the ejector shroud form a mixer-ejector pump which provides increased fluid velocity near the inlet of the turbine shroud at the cross-sectional area of the rotor plane. The mixer/ejector pump can transfer energy from the bypass flow to the rotor wake flow by both axial and stream-wise voracity, thereby allowing higher energy-extraction per unit mass flow rate through the rotor. The increased flow through the rotor, combined with increased mixing, can result in an increase in the overall power production of the shrouded fluid turbine system.

In some embodiments, the shrouded or ducted fluid turbines discussed herein provide increased efficiency in generating electrical energy from fluid currents while requiring increased surface area in those fluid currents. The increased surface area can result in increased loading on the structural components of the shrouded fluid turbine. This increased loading provides radial directional forces that yaw the shrouded turbine into the fluid flow. A passive yaw system mitigates the negative effects of the increased structural loading by allowing the shrouded turbine to rotate to a position of least fluid-flow resistance.

The shrouded turbine and shrouds discussed herein can provide a platform for an integrated passive yaw and an active yaw system. As will be discussed below and as should be understood by those of ordinary skill in the art, active yawing can be provided by using a variety of mechanisms and drive arrangements, e.g., one or more geared drive units engaged with a slew ring between a bearing race between the tower and shrouded turbine, and the like. The geared drive unit can be actuated, e.g., electrically, hydraulically, electromechanically, or combinations thereof. Passive yawing can be provided using a variety of the techniques or mechanism discussed herein. For example, components, such as one or more clutches integrated into the one or more gearing mechanisms, can be mechanically disengaged such that passive yawing can be used in fluid-flow velocities below the cut-in fluid flow velocity, above the cut-out fluid-flow velocity and during grid loss or other protection system modes. In some embodiments, passive yawing may occur by overriding an integral “slip clutch” or torque-limiter, e.g., a torque limiting mechanism. The torque-limiter can be provided by a pinion gear that is rotationally engaged with a drive shaft and engaged with friction material between two pressure plates. The two pressure plates can be further engaged with the drive shaft such that the pressure plates rotate with the drive shaft and move laterally along the drive shaft central axis. The torque-limiter thereby allows a given amount of slip to occur between the drive shaft and the pinion gear, thereby preventing over-torqueing of the drive shaft.

A passive yaw damping system can be integrated into the yaw system of the example shrouded turbine which prevents over-torqueing caused by, e.g., excessive fluid speed, fluid gusts, and the like. In some embodiments, the passive yaw damping system can be a stand-alone component engaging the slew ring or may be integrated into the yaw system. The yaw techniques or mechanisms or both, as discussed above, when employed in combination with the example shrouded turbine, can be referred to as a hybrid yaw system.

The example shrouded turbine can be engaged with the support structure near the center of gravity of the shrouded turbine while pivoting about the support structure about an axis that is offset from the center of pressure. The center of pressure generally defines the point on the shrouded turbine where the total sum of the pressure field causes a force and no moment-force about that point. The center of pressure of a shrouded turbine is typically near the downwind portion of the rotor plane. The point at which the support structure engages the shrouded turbine is typically behind the rotor plane at the nacelle. Thus, the shrouded turbine can provide passive yaw at most fluid-flow velocities. The passive yaw system can thereby be activated by disengaging at least one clutch at the shrouded turbine cut-in velocity and continues to assist in yawing the shrouded turbine through the cut-out velocity when the at least one clutch or break can be engaged to shut down the shrouded turbine. The active yaw system can be employed to control the shrouded turbine in fluid-flow velocities within the range from the cut-in speed to a predetermined fluid velocity range. The predetermined fluid velocity range can be, e.g., between approximately 8 m/s and approximately 12 m/s. In some embodiments, rather than a predetermined fluid velocity range, a predetermined fluid velocity of, e.g., approximately 10 m/s, can be used. This type of active yaw system can be referred to as controlling-active yaw and can be used to yaw the shrouded turbine when the fluid-flow velocity is not sufficient for the passive yaw system to move the shrouded turbine. A combination of the active-yaw system and the passive-yaw system can be employed from the predetermined fluid velocity range to the cut-out fluid-flow velocity. The predetermined fluid velocity range can be, e.g., between approximately 8 m/s and approximately 12 m/s. In some embodiments, rather than a predetermined fluid velocity range, a predetermined fluid velocity of, e.g., approximately 10 m/s, can be used. In this fluid-flow velocity range the forces on the shrouded turbine are sufficient for the passive yaw system to move the shrouded turbine. This type of yaw control can be referred to as supporting-active yaw in combination with functional-passive yaw.

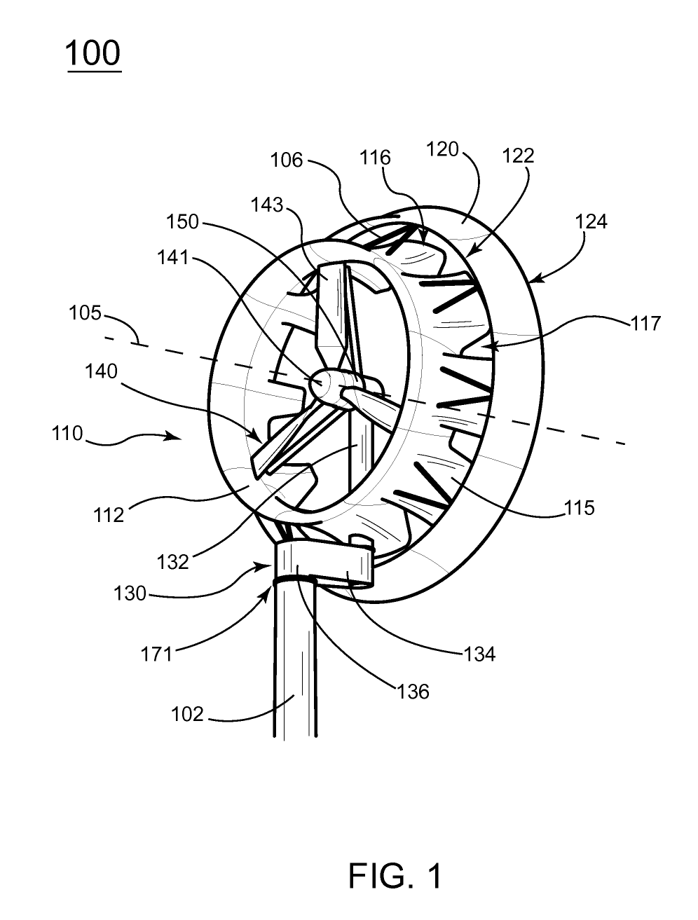

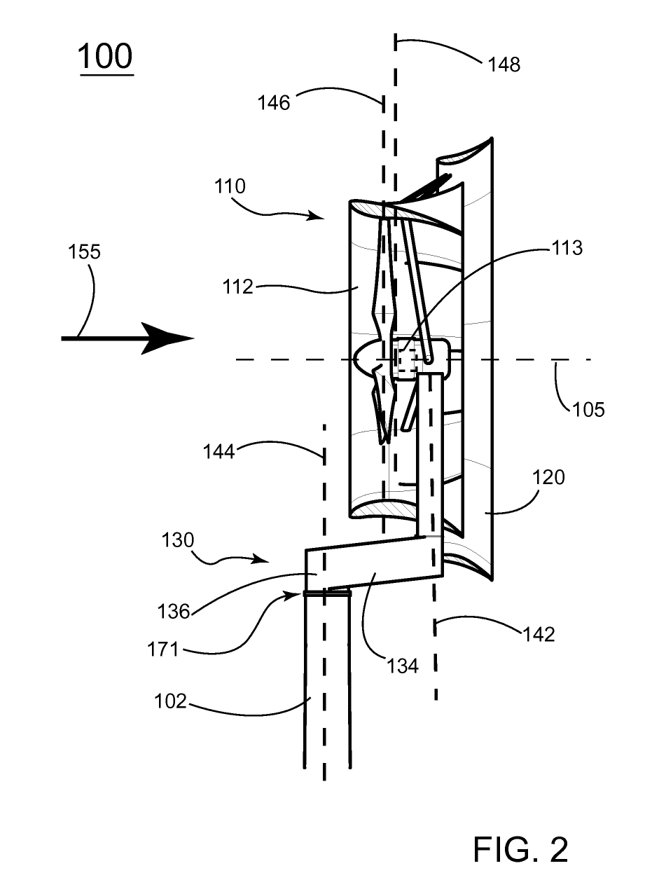

Turning now to FIG. 1, a perspective view of one example embodiment of a shrouded fluid turbine 100 (hereinafter “shrouded turbine 100”) is provided. Numerous alternative shrouded or ducted fluid turbines may employ the features of the present invention. Thus, as would be understood by those of ordinary skill in the art, the example embodiment of shrouded turbine 100 illustrated in FIG. 1 is not intended to be limiting in scope and is for illustrative purposes. FIG. 2 is a side view of the shrouded turbine 100 and illustrates the location of a center of gravity 142, a center of pressure 148 and a pivot axis 144 of the shrouded turbine 100 for the passive yaw system.

With reference to FIGS. 1 and 2, in this example embodiment, the shrouded turbine 100 includes a turbine shroud 110, a nacelle body 150, a rotor 140 and an ejector shroud 120. As will be discussed in greater detail below, in some embodiments, the shrouded turbine 100 can be fabricated without the ejector shroud 120 and the components associated with the ejector shroud 120, e.g., the support members 106.

The turbine shroud 110 defines a front end 112, e.g., an inlet, a leading edge, and the like. The turbine shroud 110 also defines a rear end 116, e.g., an outlet, an exhaust end, a trailing edge, and the like. The rear end 116 defines outward curving mixing elements 117 and inward curving mixing elements 115, e.g., mixing lobes, configured and dimensioned to mix the fluid flowing through the turbine shroud 110. The ejector shroud 120 defines a front end 122, e.g., an inlet, a leading edge, and the like, and a rear end 124, e.g., an outlet, an exhaust end, a trailing edge, and the like. Support members 106 can be used as depicted in FIGS. 1 and 2 to connect the turbine shroud 110 to the ejector shroud 120 and provide structural support to the ejector shroud 120 relative to the turbine shroud 110. In single shroud embodiments, the shrouded turbine 100 further includes a tower 102 configured and dimensioned to rotationally support the assembly of the turbine shroud 110, the rotor 140, and the associated components thereon. In dual shroud embodiments, the tower 102 can be configured and dimensioned to rotationally support the assembly of the turbine shroud 110, the rotor 140, the ejector shroud 120, and the associated components thereon.

As set forth above, the arrangement of the turbine shroud 110 and ejector shroud 120 of shrouded turbine 100 is solely illustrative of one example shrouded fluid turbine 100 according to the present disclosure. Thus, the shrouded fluid turbine 100 arrangement illustrated in FIG. 1 is not intended to be limiting in scope. In particular, those of ordinary skill in the art should understand that the example embodiments discussed herein can be utilized with numerous or varying horizontal shrouded turbines. In addition, the passive yaw system discussed herein that includes an offset between the center of pressure and the center of gravity can represent one of the example embodiments of a suitable passive yaw arrangement. Thus, in accordance with the present disclosure, passive yaw may also be provided based on the aerodynamic shape or orientation of the shrouded turbine 100 assembly, or may utilize various alternative aerodynamic aids.

The rotor 140, turbine shroud 110 and ejector shroud 120 can be coaxially aligned relative to each other, i.e. the rotor 140, turbine shroud 110 and ejector shroud 120 share a common central axis 105. Thus, the rotor 140 can be positioned centrally within the turbine shroud 110 along central axis 105. The rotor 140 can surround the nacelle body 150 and includes a central hub 141 positioned coaxially with the central axis 105. The nacelle body 150 can include therein electrical generation equipment 113. The rotor 140 also includes one or more blades 143 which include a proximal end connected to the central hub 141 and a distal end extending in the direction of the inner walls of the turbine shroud 110. The central hub 141 can be rotationally engaged with the nacelle body 150. The shrouded turbine 100 further includes a support structure 130 which includes an upper vertical member 132 engaged with the nacelle body 150 at the distal end and with a predominantly horizontal portion 134 at the proximal end. The horizontal portion 134 can be further engaged with a pivoting structure 136. The pivot point of the pivoting structure 136 can, in turn, be engaged with the upper portion of the tower 102. The engagement between the nacelle body 150, the central hub 141 and the components of the support structure 130 can provide rotational movement between said components to allow the shrouded turbine 100 to yaw with respect to a fluid-flow direction. In some embodiments, a yaw system 171 can be housed in the pivoting structure 136 to allow yawing of the pivoting structure 136, and thereby the shrouded turbine 100, relative to the tower 102.

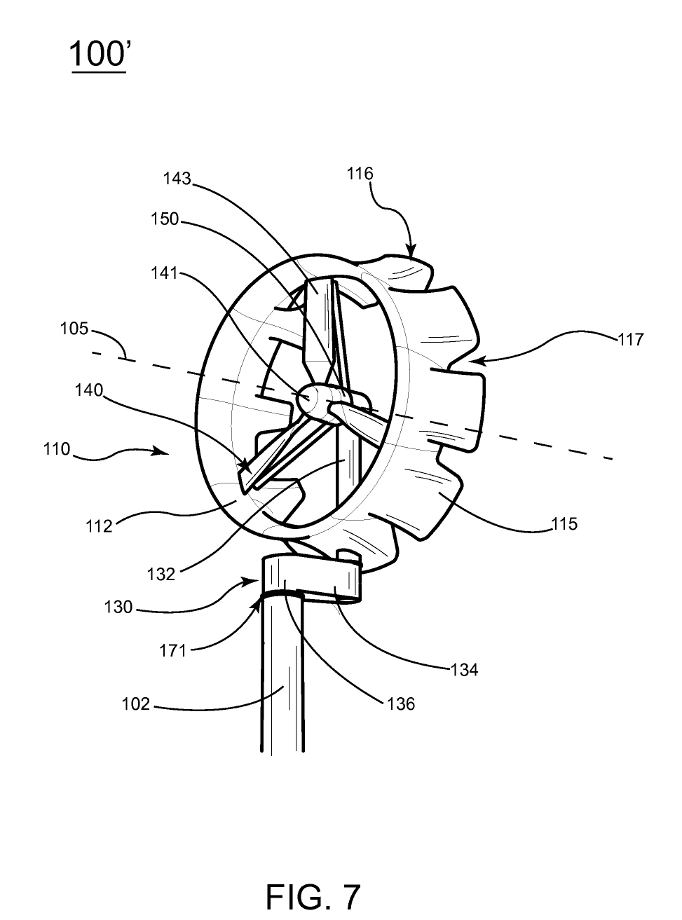

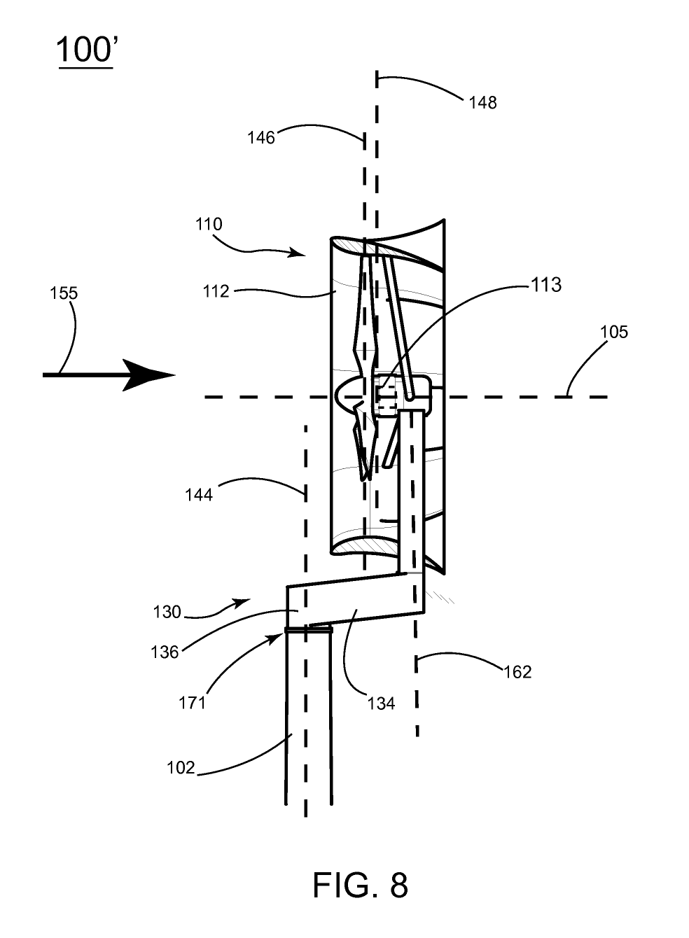

With specific reference to FIG. 2, the locations of the center of gravity 142, the pivot axis 144, the rotor plane 146 and the center of pressure 148 are illustrated with dotted lines representing each respective axis or plane. The center of pressure 148 can be positioned downstream of the rotor plane 146. The pivot axis 144 located at the center of the tower 102 can be offset from the center of pressure 148. With the center of pressure 148 offset from the pivot axis 144, a fluid stream represented by arrow 155 can exert a force on the shrouded turbine 100 such that the shrouded turbine 100 moves downstream from the pivot axis 144. The positioning of the center of pressure 148 relative to the pivot axis 144 further passively yaws the shrouded turbine 100 such that it faces into the direction of fluid flow. In particular, the location of the pivot axis 144 offset from the center of pressure 148 passively yaws the shrouded turbine 100 to maintain the ejector shroud 120 downstream of the leading edge 112 of the turbine shroud 110. The passive yawing is equally applicable to dual shroud fluid turbines as depicted in FIGS. 1-3 and single shroud fluid turbines as depicted in FIGS. 7 and 8. The center of pressure 148 generally defines the point on the shrouded turbine 100 where the total sum of the pressure field causes a force and no moment-force about that point. The center of pressure 148 of a shrouded turbine 100 is typically near the downwind portion of the rotor plane 146. The point at which the support structure 130 engages the shrouded turbine 100 is typically behind the rotor plane 146 at the nacelle 150.

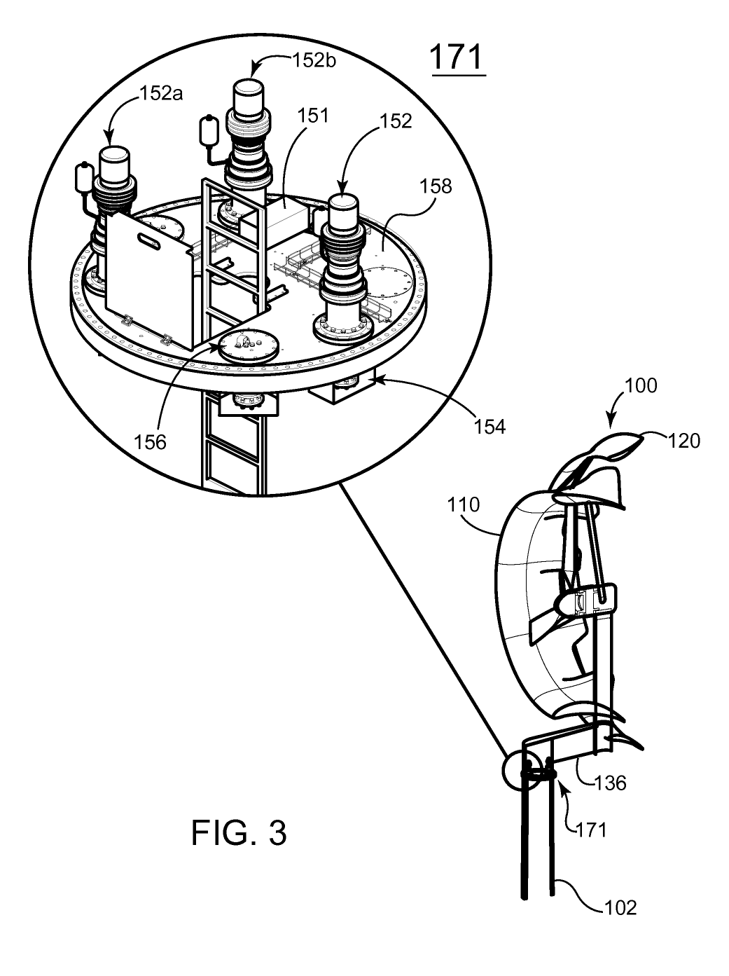

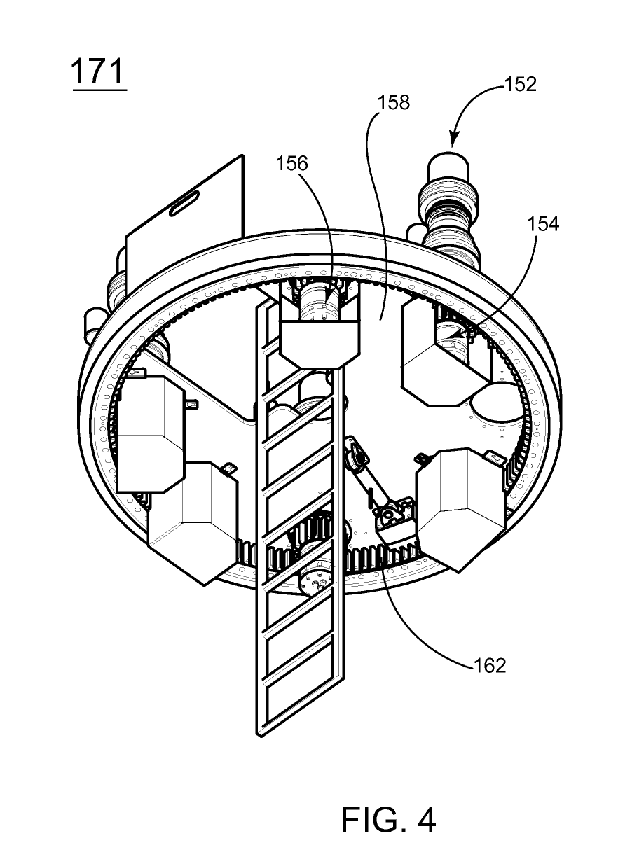

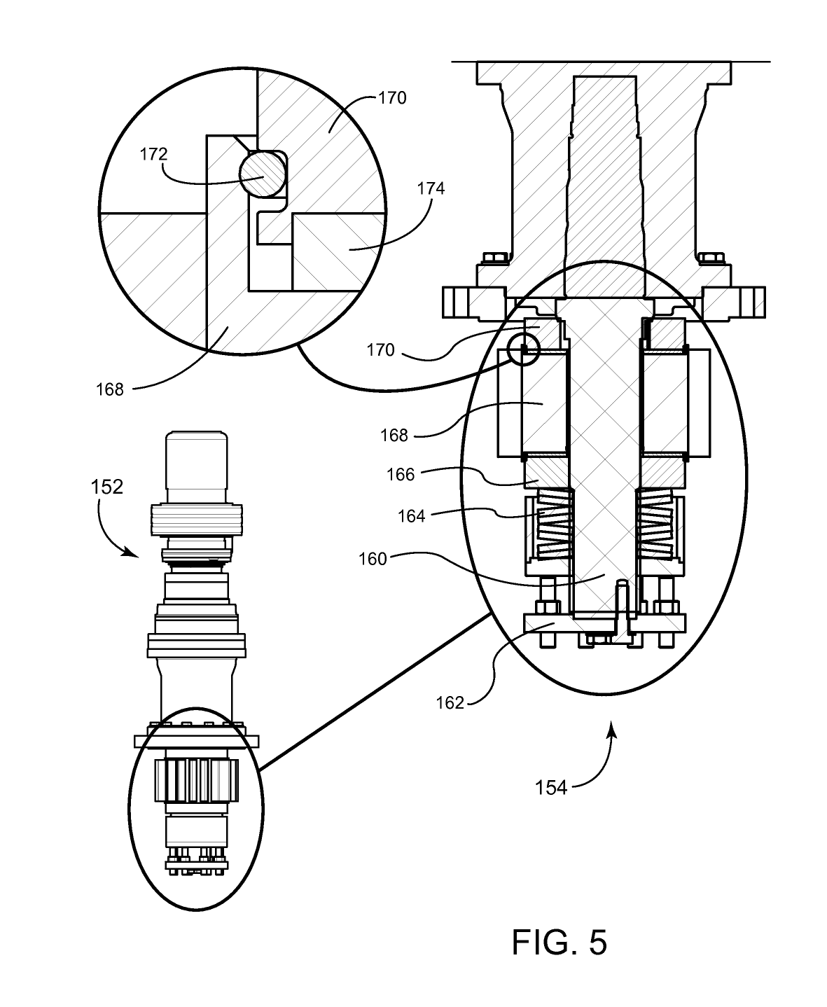

In addition to the passive yaw system, shrouded turbine 100 can include an active yaw system. FIG. 3 depicts a top perspective view of an example active yaw system 171 for shrouded turbine 100. FIG. 4 depicts a bottom perspective view of the active yaw system 171. FIG. 5 depicts a side cross-sectional and detailed view of a portion of the active yaw system 171. The active yaw system 171 can be used in combination with the passive yaw system describe above as a hybrid yaw system for shrouded turbine 100.

With reference to FIGS. 3-5, the active yaw system 171, such as that of the example embodiment, can be located in the tower 102 of the shrouded turbine 100 and includes at least one motor-gear stack 152. The motor-gear stack 152 illustrated in FIGS. 3-5 can be engaged with the shrouded turbine pivoting-structure 136 and can be rotationally engaged with the tower 102. In some example embodiments, as shown in FIG. 3, a plurality of motor-gear stacks 152, 152a, 152b can be used. In some example embodiments, one motor-gear stack 152 can be used. The motor-gear stack 152 can include a set of reduction gears (not shown) that culminate at a drive shaft 160. The drive shaft 160 can be engaged with the pinion gear 168 and the pinion gear 168 can be engaged with a ring gear 162. The ring gear 162 can be affixed to the tower 102. The motor-gear stack 152 can be engaged to a top plate 158 that can be further engaged with the shrouded turbine pivoting-structure 136. Thus, as the pinion gear 168 is actuated to rotate with, e.g., an actuation mechanism, the active yaw system 171 and, thereby, the shrouded turbine pivoting-structure 136, can be rotated relative to the tower 102 for actively yawing the shrouded turbine 100. In some example embodiments, the active yaw system 171 can include a sensor 151 configured to determine the yawing position of the shrouded turbine 100 relative to the tower 102 and regulate actuation of the active yaw system 171 to appropriately yaw the shrouded turbine 100 relative to the tower 102. It should be understood that the active yaw system 171 discussed herein is not intended to be limiting in scope of the present invention. Rather, FIGS. 3-5 represent an example embodiment of an active yaw system 171. In some embodiments, the active yaw system 171 can be, e.g., a direct drive arrangement without an intermediate gearbox, and the like. In such embodiments, a suitable mechanism should be provided to allow the passive yaw to function as described above.

The example active yaw system 171 can further include a torque limiter 154, i.e., a torque limiting mechanism, engaged with the drive shaft 160 of the motor-gear stack 152. In particular, the drive shaft 160 can be rotationally engaged with an upper pressure plate 170 and a lower pressure plate 166. Upper and lower pressure plates 170 and 166 can be fixedly engaged with the drive shaft 160 by, e.g., splines, keys, and the like, that allow longitudinal movement along the drive shaft 160 and fixed rotational engagement with the drive shaft 160. The pinion 168 can be rotationally engaged with the drive shaft 160. A friction material 174, e.g., a rubber material, and the like, can be positioned adjacent to the pinion 168. A disc spring 164 can be held under compression by a bolt plate 162 against the lower pressure plate 166. The compression force of the disc spring 164 against the lower pressure plate 166 and, in turn, the upper pressure plate 170, in combination with the friction material 174 surrounding the pinion 168, can limit the amount of torque on the pinion 168. An O-ring 172 can maintain a clean environment for the friction material 174 by preventing debris from entering the space between the upper pressure plate 170 and the pinion 168. Maintenance related to the tension of the disc spring 164 and the pinion 168 can be performed by access to the lower portion of the yaw drive motor-gear stack 152. The active yawing system 171 is equally applicable to dual shroud fluid turbines as depicted in FIGS. 1-3 and single shroud fluid turbines as depicted in FIGS. 7 and 8.

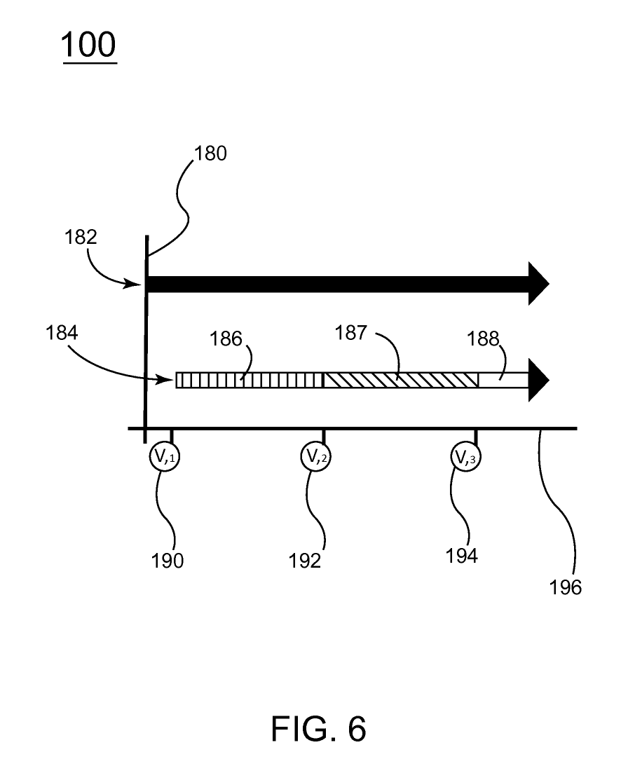

Turning now to FIG. 6, a diagram illustrating the relationship between fluid-flow velocities and the employment of passive and active yaw systems of the shrouded turbine 100 is provided. An application of the passive yaw system is depicted by the solid arrow 182 and an application of the active yaw system is depicted by a segmented arrow 184 located along the vertical axis 180. The horizontal axis 196 represents the cut-in speed of the shrouded turbine V_{,1} 190, the fluid-flow velocity at which rated power occurs V_{,2} 192 and the cut-out fluid-flow velocity V_{,3} 194 along the horizontal axis 196. In the region depicted by the segment 186 in arrow 184, the active yaw controls the direction of the shrouded turbine 100 as the efficacy of the passive system is less than optimal, i.e., the fluid flow velocity is insufficient to passively yaw the shrouded turbine 100. In the region depicted by the segment 187 in arrow 184, a combination of active and passive yaw can be employed. In the region depicted by the segment 188 in arrow 184, the fluid-flow velocity is above the operating range of the shrouded turbine 100. Thus, the shrouded turbine 100 can be placed in a shut-down mode. In particular, in the shut-down mode, the active yaw mechanism can employ one or more clutches or brakes to prevent the shrouded turbine 100 from moving. Some slippage may be allowed such that the passive yaw system can rotate the shrouded turbine 100 into a direction of least resistance against the fluid-flow to prevent excessive loads on the shrouded turbine 100.

FIGS. 7 and 8 depict an example embodiment of a shrouded turbine 100′ having a single turbine shroud 110. In particular, the example shrouded turbine 100′ includes some of the components of shrouded turbine 100 (represented by like numeric designations), except that shrouded turbine 100′ is free of an ejector shroud 120 and the components associated with the ejector shroud 120. Thus, it should be understood that the example shrouded turbine 100′ can be provided without an ejector shroud 120 and support members 106 for securing the turbine shroud 110 relative to the ejector shroud 120, while functioning substantially similarly to the shrouded turbine 100 discussed above. Thus, the example embodiment of the shrouded turbine 100′ also includes passive yawing, as discussed with respect to FIGS. 1, 2 and 6, and active yawing, as discussed with respect to FIGS. 3-5.

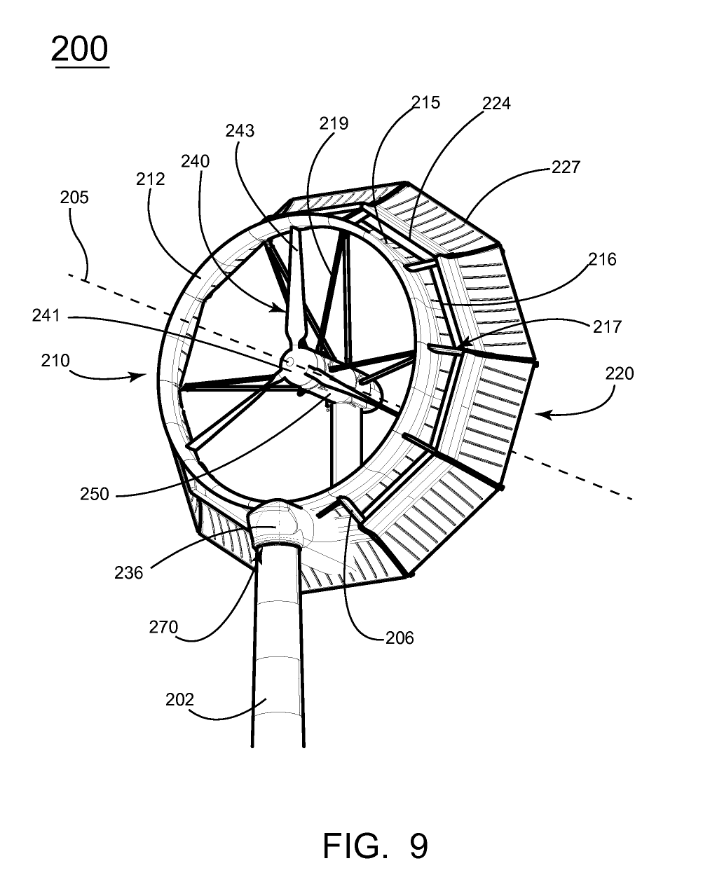

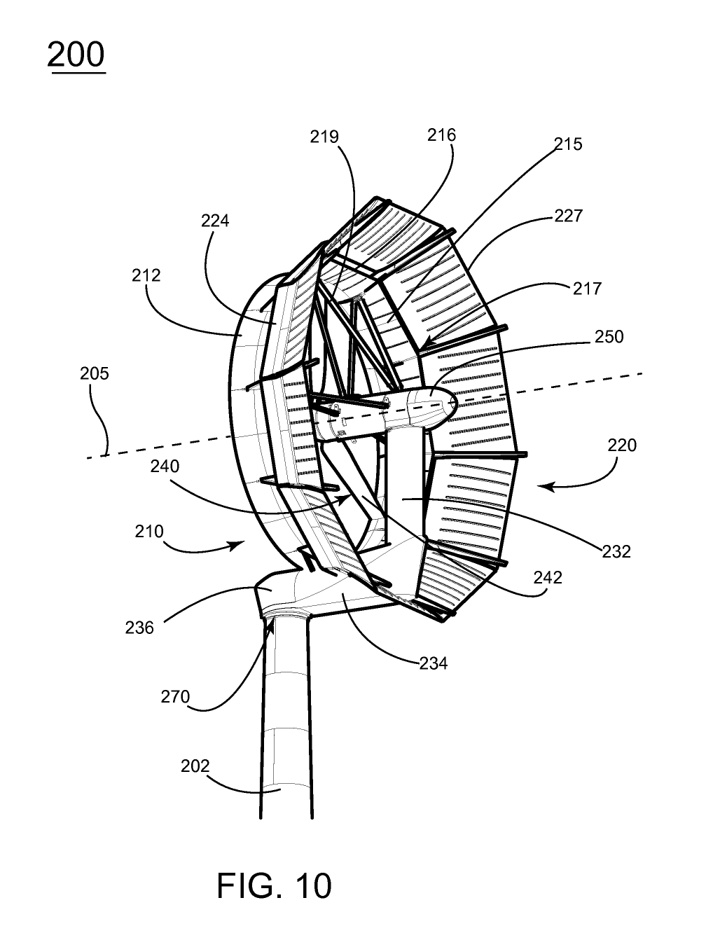

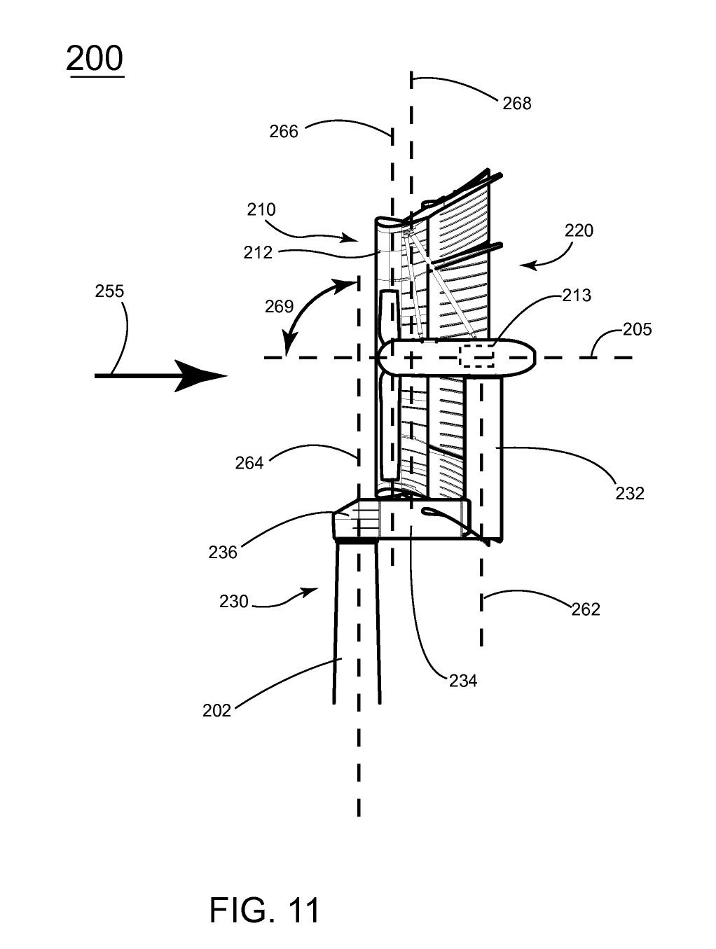

FIGS. 9 and 10 are front and rear perspective views, respectively, of an example embodiment of a shrouded turbine 200 including example airfoils, i.e., an example turbine shroud 210 and an example ejector shroud 220. FIG. 11 is a side view of an example embodiment of a shrouded turbine 200 and illustrates the location of a center of gravity 262, a center of pressure 268 and a pivot axis 264 of the shrouded turbine 200 for the passive yaw system.

With reference to FIGS. 9-11, the shrouded fluid turbine 200 includes a turbine shroud 210, a nacelle body 250, a rotor 240 and an ejector shroud 220. The turbine shroud 210 and the ejector shroud 220 can define a faceted edges or sides. Although illustrated as a dual shroud turbine 200, i.e., a shrouded turbine including the turbine shroud 210 and the ejector shroud 220, in some embodiments, the turbine 200 can be a single shroud turbine, i.e., a shrouded turbine including the turbine shroud 210 and free of the ejector shroud 220. The turbine shroud 210 includes a front end 212, e.g., an inlet or a leading edge. The turbine shroud 210 further includes a rear end 216, e.g., an exhaust end or a trailing edge. The rear end 216 includes substantially linear segments 215 joined at nodes 217. In some embodiments, the rear end 216 of the turbine shroud 210 can include a multi-sided polygon shape having a faceted structure. For example, the rear end 216 can include facets, i.e., linear segments 215, enjoined at nodes 217. The ejector shroud 210 includes a front end 224, e.g., an inlet end or a leading edge, and a rear end 227, e.g., an exhaust end or a trailing edge. The ejector shroud 210 can include a faceted annular airfoil for which the front end 224. In some example embodiments, the rear end 227 of the ejector shroud 220 can include a multi-sided polygon shape having a faceted structure. For example, the rear end 227 can include facets enjoined at nodes. Support members 206 can connect the turbine shroud 210 to the ejector shroud 220. Support members 219 can connect the turbine shroud 210 to the nacelle body 250.

The rotor 240 surrounds the nacelle body 250 and includes a central hub 241 at the proximal end of the rotor blades 242. The nacelle body 250 can include electrical generation equipment 213 located therein. The central hub 241 can be rotationally engaged with the nacelle body 250. The rotor 240, the turbine shroud 210 and the ejector shroud 220 can be coaxial relative to each other, i.e., the rotor 240, the turbine shroud 210 and the ejector shroud 220 can share a common central axis 205. The support structure 230 can include an upper vertical member 232 engaged at the distal end with the nacelle body 250. The support structure 230 can be further engaged at the proximal end with a predominantly horizontal portion 234. The horizontal portion 234 can be engaged with a pivoting structure 236. The pivot point of the pivoting structure 236 can, in turn, be engaged with the upper portion of the tower 202. The tower 202 thereby rotationally supports the components of the shrouded turbine 200.

With specific reference to FIG. 11, the locations of the center of gravity 262, the pivot axis 264, the rotor plane 266 and the center of pressure 268, each approximated by dotted lines, are depicted. The center of pressure 268 can be downstream of the rotor plane 266. The pivot axis 264 located at the center of the tower 202 can be offset from the center of pressure 268. In addition, the pivot axis 264 can be positioned at a perpendicular angle relative to the central axis 205 of the shrouded turbine 200, i.e., angle 269 can be approximately 90°. In some example embodiments, the centerline 205 can be non-perpendicular to the pivot axis 264. The orientation of the pivot axis 264 relative to the shroud centerline 205 can be such that the angle 269 defined by the intersection of these centerlines is a non-perpendicular angle. In accordance with example embodiments, the resulting effect of the non-perpendicular angle 269 can result in the generation of a positive lift component, as discussed above. The positive lift component can be generated, at least in part, by the turbine shroud 210 or the ejector shroud 220 orientation at an angle 269 that is not perpendicular to the pivot axis 264 and substantially perpendicular to the prevalent fluid direction 255. With the center of pressure 268 offset from the pivot axis 264, a fluid stream, represented by the solid arrow 255, can exert a force on the shrouded turbine 200. The force can move the shrouded turbine 200 downstream from the pivot axis 264. Thus, the shrouded turbine 200 can be passively yawed such that it faces the fluid-flow direction. In particular, the location of the pivot axis 264 offset from the center of pressure 268 passively yaws the shrouded turbine 200 to maintain the ejector shroud 220 downstream of the front end 212 of the turbine shroud 210. Thus, the example embodiment of the shrouded turbine 200 also includes passive yawing, as discussed with respect to FIGS. 1, 2 and 6, and can include an active yawing system 270, as discussed with respect to FIGS. 3-5.

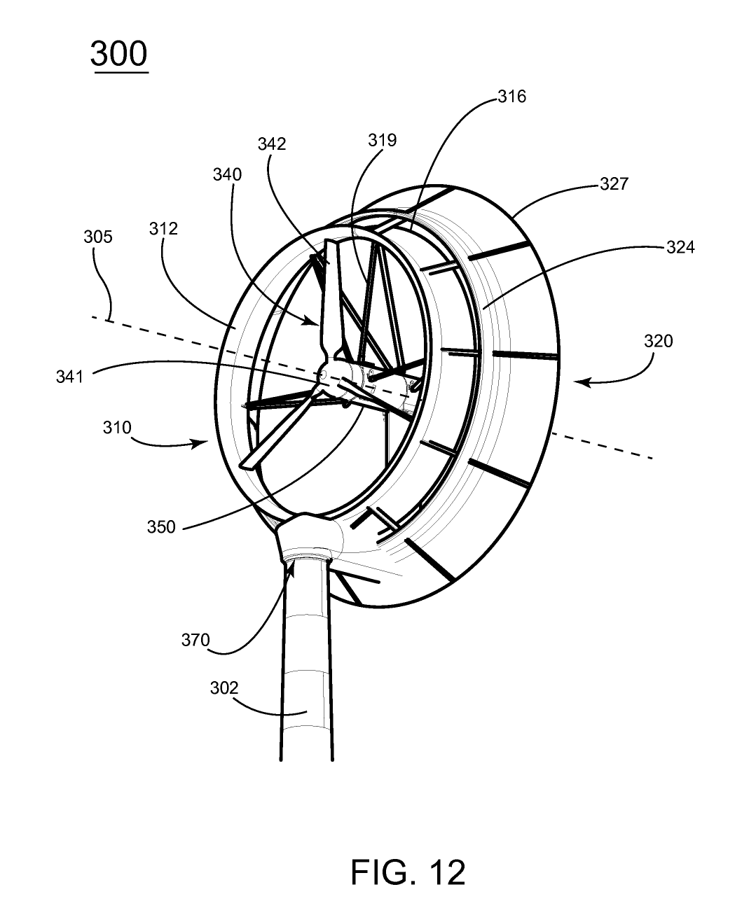

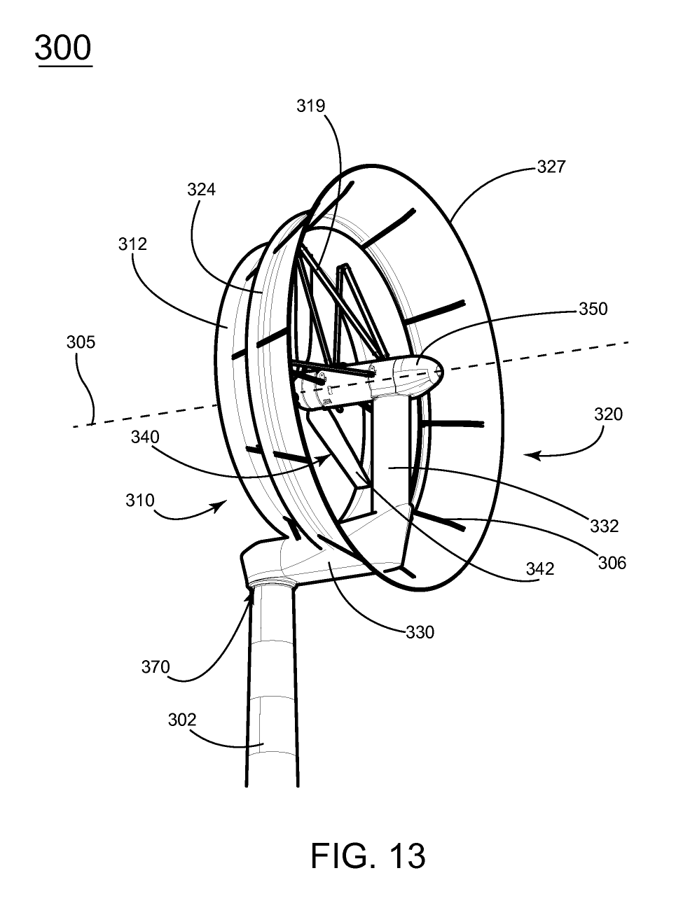

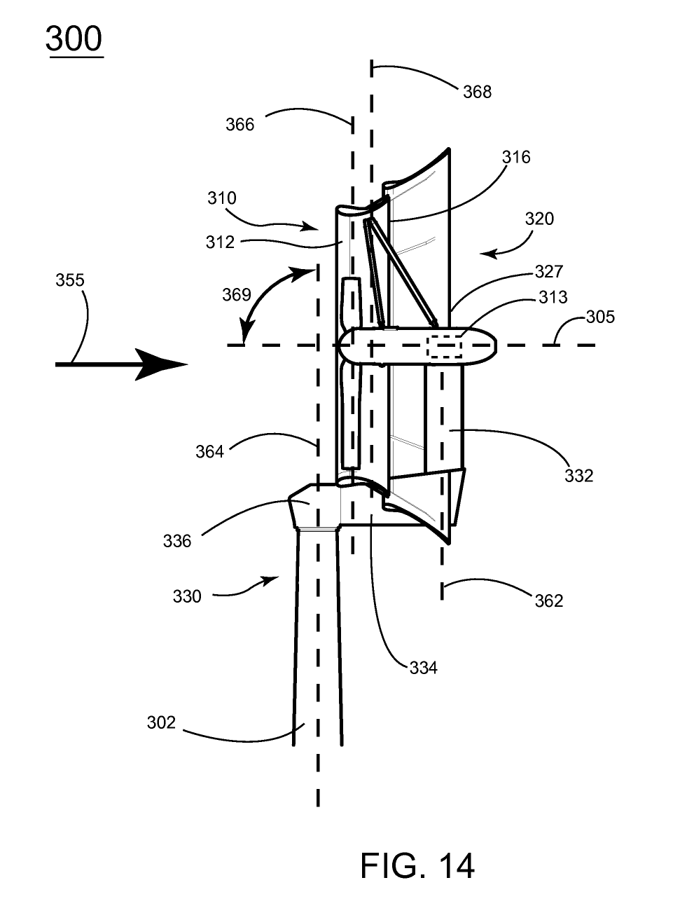

FIGS. 12 and 13 are front and rear perspective views, respectively, of an example embodiment of a shrouded turbine 300 including example airfoils, i.e., an example turbine shroud 310 and an example ejector shroud 320. FIG. 14 is a side view of an example embodiment of a shrouded turbine 300 and illustrates the location of a center of gravity 362, a center of pressure 368 and a pivot axis 364 of the shrouded turbine 300 for the passive yaw system.

With reference to FIGS. 12-14, the shrouded fluid turbine 300 includes a turbine shroud 310, a nacelle body 350, a rotor 340 and an ejector shroud 320. The turbine shroud 310 and the ejector shroud 320 can define a faceted edges or sides. Although illustrated as a dual shroud turbine 300, i.e., a shrouded turbine including the turbine shroud 310 and the ejector shroud 320, in some embodiments, the turbine 300 can be a single shroud turbine, i.e., a shrouded turbine including the turbine shroud 310 and free of the ejector shroud 320. The turbine shroud 310 includes a front end 312, e.g., an inlet or a leading edge. The turbine shroud 310 further includes a rear end 316, e.g., an exhaust end or a trailing edge. The rear end 316 includes a substantially linear segments 315 joined at nodes 317. The ejector shroud 310 includes a front end 324, e.g., an inlet end or a leading edge, and a rear end 327, e.g., an exhaust end or a trailing edge. Support members 306 can connect the turbine shroud 310 to the ejector shroud 320. Support members 319 can connect the turbine shroud 310 to the nacelle body 350.

The rotor 340 surrounds the nacelle body 350 and includes a central hub 341 at the proximal end of the rotor blades 342. The nacelle body 350 can include electrical generation equipment 313 located therein. The central hub 341 can be rotationally engaged with the nacelle body 350. The rotor 340, the turbine shroud 310 and the ejector shroud 320 can be coaxial relative to each other, i.e., the rotor 340, the turbine shroud 310 and the ejector shroud 320 can share a common central axis 305. The support structure 330 can include an upper vertical member 332 engaged at the distal end with the nacelle body 350. The support structure 330 can be further engaged at the proximal end with a predominantly horizontal portion 334. The horizontal portion 334 can be engaged with a pivoting structure 336. The pivot point of the pivoting structure 336 can, in turn, be engaged with the upper portion of the tower 302. The tower 302 thereby rotationally supports the components of the shrouded turbine 300.

With specific reference to FIG. 14, the locations of the center of gravity 362, the pivot axis 364, the rotor plane 366 and the center of pressure 368, each approximated by dotted lines, are depicted. The center of pressure 368 can be downstream of the rotor plane 366. The pivot axis 364 located at the center of the tower 302 can be offset from the center of pressure 368. In addition, the pivot axis 364 can be positioned at a perpendicular angle relative to the central axis 305 of the shrouded turbine 300, i.e., angle 369 can be approximately 90°. In some example embodiments, the centerline 305 can be non-perpendicular to the pivot axis 364. The orientation of the pivot axis 364 relative to the shroud centerline 305 can be such that the angle 369 defined by the intersection of these centerlines is a non-perpendicular angle. In accordance with example embodiments, the resulting effect of the non-perpendicular angle 369 can result in the generation of a positive lift component, as discussed above. The positive lift component can be generated, at least in part, by the turbine shroud 310 or the ejector shroud 320 orientation at an angle 369 that is not perpendicular to the pivot axis 364 and substantially perpendicular to the prevalent fluid direction 355. With the center of pressure 368 offset from the pivot axis 364, a fluid stream, represented by the solid arrow 355, can exert a force on the shrouded turbine 300. The force can move the shrouded turbine 300 downstream from the pivot axis 364. Thus, the shrouded turbine 300 can be passively yawed such that it faces the fluid-flow direction. In particular, the location of the pivot axis 364 offset from the center of pressure 368 passively yaws the shrouded turbine 300 to maintain the ejector shroud 320 downstream of the front end 312 of the turbine shroud 310. Thus, the example embodiment of the shrouded turbine 300 also includes passive yawing, as discussed with respect to FIGS. 1, 2 and 6, and can include an active yawing system 370, as discussed with respect to FIGS. 3-5.

While example embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A shrouded fluid turbine, comprising:
a turbine shroud including a plurality of mixer elements,
a rotor disposed within the turbine shroud, and
a hybrid yaw system having a passive yaw system and an active yaw system for regulating a yaw of the shrouded fluid turbine,
wherein the hybrid yaw system includes a torque limiting mechanism.

2. The shrouded fluid turbine according to claim 1, wherein the turbine shroud defines a turbine shroud inlet and a turbine shroud outlet.

3. The shrouded fluid turbine according to claim 2, wherein the rotor is disposed downstream of the turbine shroud inlet.

4. The shrouded fluid turbine according to claim 1, wherein the rotor further comprises a hub and at least one rotor blade engaged with the hub.

5. The shrouded fluid turbine according to claim 4, wherein the plurality of mixer elements extend downstream of the at least one rotor blade.

6. The shrouded fluid turbine according to claim 1, wherein the plurality of mixer elements are arranged in a ring configuration.

7. The shrouded fluid turbine according to claim 2, further comprising an ejector shroud surrounding the plurality of mixer elements, the ejector shroud defining an ejector shroud inlet and an ejector shroud outlet.

8. The shrouded fluid turbine according to claim 1, further comprising a nacelle including therein electrical generation equipment.

9. The shrouded fluid turbine according to claim 1, wherein the passive yaw system is a continuous-passive yaw system and the active yaw system is at least one of a momentary-active yaw system, a controlling-active yaw system and a supporting-active yaw system.

10. The shrouded fluid turbine according to claim 9, wherein the passive yaw system is engaged from a cut-in fluid velocity to a cut-out fluid velocity, the controlling-active yaw system is engaged from the cut-in fluid velocity to a predetermined fluid velocity range, and a combination of the passive yaw system and the supporting-active yaw system is engaged between the predetermined fluid velocity range and the cut-out fluid velocity.

11. The shrouded fluid turbine according to claim 10, where the predetermined fluid velocity range is between 8 m/s and 12 m/s.

12. The shrouded fluid turbine according to claim 1, wherein the torque limiting mechanism comprises at least one drive shaft, a pinion gear, a friction material, and at least one pressure plate.

13. The shrouded fluid turbine according to claim 12, wherein the at least one drive shaft is rotationally engaged with the pinion gear, the pinion gear is engaged with the friction material, the friction material is engaged with the at least one pressure plate, and the at least one pressure plate is laterally engaged with the at least one drive shaft.

14. The shrouded fluid turbine according to claim 13, wherein the torque limiting mechanism allows slippage of the pinion gear relative to the at least one drive shaft when the at least one drive shaft is over-torqued.

15. The shrouded fluid turbine according to claim 7, wherein at least one of the turbine shroud and the ejector shroud includes faceted sides.

16. A method of yawing a shrouded fluid turbine, comprising:
providing a shrouded fluid turbine, the shrouded fluid turbine including (i) a turbine shroud including a plurality of mixer elements, (ii) a rotor disposed within the turbine shroud, and (iii) a hybrid yaw system having a passive yaw system and an active yaw system for regulating a yaw of the shrouded fluid turbine, wherein the hybrid yaw system includes a torque limiting mechanism, and
yawing the shrouded fluid turbine via the hybrid yaw system.

17. The method according to claim 16, wherein the passive yaw system and the active yaw system yaw the shrouded fluid turbine into a fluid-flow direction.

18. The method according to claim 17, wherein the passive yaw system is a continuous-passive yaw system and the active yaw system is at least one of a momentary-active yaw system, a controlling-active yaw system and a supporting-active yaw system.

19. A hybrid yaw system for a shrouded fluid turbine, comprising:
a shrouded fluid turbine assembly rotationally engaged with a tower,
a passive yaw system associated with the shrouded fluid turbine assembly, and
an active yaw system associated with the shrouded fluid turbine assembly,
wherein at least one of the passive yaw system and the active yaw system regulate a yaw of the shrouded fluid turbine assembly relative to the tower, and
wherein the active yaw system includes a torque limiting mechanism.

20. The hybrid yaw system according to claim 19, wherein the active yaw system is at least one of a controlling-active yaw system and a supporting-active yaw system.
